(19) United States
(12) Patent Application Publication
(10) Pub. No.: US 2007/0211808 A1
(43) Pub. Date: Sep. 13, 2007

(54) Method for self-calibration in a mobile receiver

(75) Inventors: Hyun-Il Kang, Hwaseong-si (KR); Jae-Kon Lee, Suwon-si (KR); Hyeong-Seok Yu, Seoul (KR); Sang-Hyun Woo, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/709,910

(22) Filed: Feb. 22, 2007

(30) Foreign Application Priority Data
Feb. 22, 2006 (KR) 17199-2006

(51) Int. Cl. H04K 1/10

(52) U.S. Cl. 375/260

(57) ABSTRACT

Provided is an apparatus and method for calibrating an imbalance characteristic of a received signal of a frequency domain in a mobile receiver which supports an Orthogonal Frequency Division Multiplexing (OFDM) scheme. To this end, a received signal of a radio frequency band is converted into a baseband signal by using a carrier, and the baseband received signal is converted from a time domain signal to a frequency domain signal. Then, a calibration coefficient is measured by using two consecutively received signals from the Fast Fourier Transform (FFT) unit. An imbalance component included in the received signal of the frequency domain due to an imbalance of the carrier is removed by using the measured calibration coefficient. In this case, the two consecutively received signals refer to two transmission signals consecutively transmitted from a transmitter, and the two transmission signals are predetermined signals.

### PRIORITY

This application claims priority under 35 U.S.C. 119(a) to an application entitled “Method For Self-Calibration In Mobile Receiver” filed in the Korean Intellectual Property Office on Feb. 22, 2006 and assigned Serial No. 2006-17199, the entire contents of which are incorporated herein by reference.

### BACKGROUND OF THE INVENTION

1. Field of the Invention

The present invention relates generally to a method for self-calibration in a mobile receiver, and in particular, to a method for self-calibrating, in a frequency domain, and mismatching between orthogonal signals in a mobile receiver.

2. Description of the Related Art

In general, non-ideal characteristics such as Direct Current (DC) offset, mismatching (i.e., Inphase/Quadrature (I/Q) imbalance), etc. are the fundamental causes of performance degradation in a mobile receiver.

The DC offset is caused by self-mixing of a mixer in a mobile receiver. That is, the DC offset occurs when a signal of a Local Oscillator (LO) returns after leaking towards an antenna, or when a Radio Frequency (RF) modulation signal input through the antenna leaks to the LO. A DC offset value generated in this manner may saturate a BB(Base Band) circuit.

A defect in an oscillator and a line connected between the oscillator and a mixer causes the I/Q imbalance. By designing the mixer to have a symmetrical structure can reduce the I/Q imbalance. However, designing the mixer with a symmetrical structure requires an increase in current consumption as well as an increase in the volume of the mixer. This I/Q imbalance decreases the Signal-to-Noise Ratio (SNR), thereby increasing a Bit Error Rate (BER), which causes degradation in the performance of the mobile receiver.

Such performance degradation due to the DC offset and/or I/Q imbalance is similarly generated even in a mobile transceiver supporting an Orthogonal Frequency Division Multiplexing (OFDM) scheme.

Generally, solutions for measuring and calibrating an I/Q imbalance in a mobile transceiver supporting the OFDM scheme have been provided. Representative examples of the solutions include PCT publication No. WO 2004/023667 and U.S. Pat. No. 5,949,821.

As described above, the conventional measurement of an I/Q imbalance characteristic is performed in the time domain. However, the scheme of measuring an I/Q imbalance characteristic in the time domain is unsuitable for application to an OFDM mobile receiver using a broadband channel, because the scheme uses only one frequency as a test signal in a baseband. That is, when an I/Q imbalance characteristic is measured in the time domain in an OFDM mobile receiver using a broadband channel, frequency components other than a baseband frequency used for calibration, may deteriorate due to a fixed calibration value. Simply, there is a problem in that performance of calibrating an I/Q imbalance characteristic is degraded.

According to the solution disclosed in U.S. Patent Publication No. 2004/0095993, an I/Q imbalance characteristic is measured in the frequency domain, and then is calibrated in the time domain. In this case, broadband calibration is impossible.

Therefore, it has been required to develop a method for measuring an I/Q imbalance characteristic in the frequency domain and calibrating the I/Q imbalance characteristic of a received signal in the frequency domain based on the measured I/Q imbalance characteristic, so as to enable the broadband calibration of the I/Q imbalance characteristic in an OFDM mobile transceiver.

Accordingly, it is necessary to develop a method for measuring and calibrating the I/Q imbalance characteristic so as to improve the performance in an OFDM mobile receiver.

### SUMMARY OF THE INVENTION

Accordingly, the present invention has been made to solve the above-mentioned problems occurring in the conventional art, and an object of the present invention is to provide a mobile receiving apparatus and a method for measuring an imbalance characteristic of a receiver in a frequency domain.

It is another object of the present invention to provide an apparatus and method for measuring and calibrating an imbalance characteristic in the frequency domain of a receiver, in an Orthogonal Frequency Division Multiplexing (OFDM) mobile transceiver.

It is still another object of the present invention to provide an apparatus and method for applying a predetermined test signal using a transmitter, and measuring and calibrating an imbalance characteristic in the frequency domain of a receiver, in an OFDM mobile transceiver.

It is yet still another object of the present invention to provide an apparatus and method for measuring and calibrating an imbalance characteristic of a receiver suitable for a broadband channel in an OFDM mobile transceiver.

It is still further another object of the present invention to provide an apparatus and method for enabling a receiver to simultaneously perform channel estimation and calibration of an imbalance characteristic, by using a pilot signal.

It is also another object of the present invention to provide an apparatus and method for measuring and calibrating an imbalance characteristic of a receiver without using multiplication and division operations, in an OFDM mobile transceiver.

It is also still another object of the present invention to provide an apparatus and method for easily obtaining and calibrating an imbalance factor, in which a transmitter inserts a known pilot pattern into two OFDM symbols, and then a receiver receives signals corresponding to the pilot pattern.

In accordance with an aspect of the present invention, there is provided an apparatus for calibrating an imbalance characteristic in a mobile receiver which supports an Orthogonal Frequency Division Multiplexing (OFDM) scheme, the apparatus including a mixer for converting a received signal of a radio frequency band into a baseband signal by using a carrier; a Fast Fourier Transform (FFT) unit for converting the baseband received signal from a time domain to a frequency domain; and an imbalance calibration unit for measuring a calibration coefficient by using two consecutive received signals from the FFT unit, and removing an imbalance component included in the received signal of the frequency domain due to a characteristic of the mixer by using the measured calibration coefficient, wherein the two consecutively received signals refer to two transmission signals consecutively-transmitted from a transmitter, and the two transmission signals are predetermined signals.

In accordance with another aspect of the present invention, there is provided a method for calibrating an imbalance characteristic in a mobile receiver which supports an Orthogonal Frequency Division Multiplexing (OFDM) scheme, the method including converting a received signal of a radio frequency band into a baseband signal by using a carrier; converting the baseband received signal from a time domain to a frequency domain; measuring a calibration coefficient by using two consecutive received signals from the FFT unit; and removing an imbalance component included in the received signal of the frequency domain due to an imbalance of the carrier, by using the measured calibration coefficient, wherein the two consecutively received signals refer to two transmission signals consecutively transmitted from a transmitter, and the two transmission signals are predetermined signals.

Preferably, the received signal of the radio frequency band refers to a transmission signal of the radio frequency band output from the transmitter, and is transferred through a test route connected between an output terminal of the transmitter and an input terminal of the receiver.

More preferably, the signals transmitted for calibration of an imbalance from the transmitter include “\tilde{Y}₋ₘ(n)=\tilde{Y}ₘ(n−1)=1” and “\tilde{Y}ₘ(n)=\tilde{Y}₋ₘ(n−1)=0.”

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of an Orthogonal Frequency Division Multiplexing (OFDM) mobile transceiver according to the present invention;

FIG. 2 is a block diagram illustrating a detailed construction of an imbalance calibration unit according to the present invention;

FIGS. 3A to 3C are graphs illustrating the waveforms of transmission and received signals generated in a mobile transceiver;

FIGS. 4A to 4C are graphs illustrating the frequency distributions of signals obtained according to the present invention; and

FIG. 5 is a block diagram illustrating another detailed construction of the imbalance calibration unit according to the present invention.

### DETAILED DESCRIPTION OF THE PREFERRED EMBODIMENT

A preferred embodiment of the present invention will now be described in detail with reference to the accompanying drawings. In the following description, a detailed description of known functions and configurations incorporated herein has been omitted for conciseness. Hereinafter, the construction of a mobile transceiver according to the present invention will be described in detail with reference to the accompanying drawings.

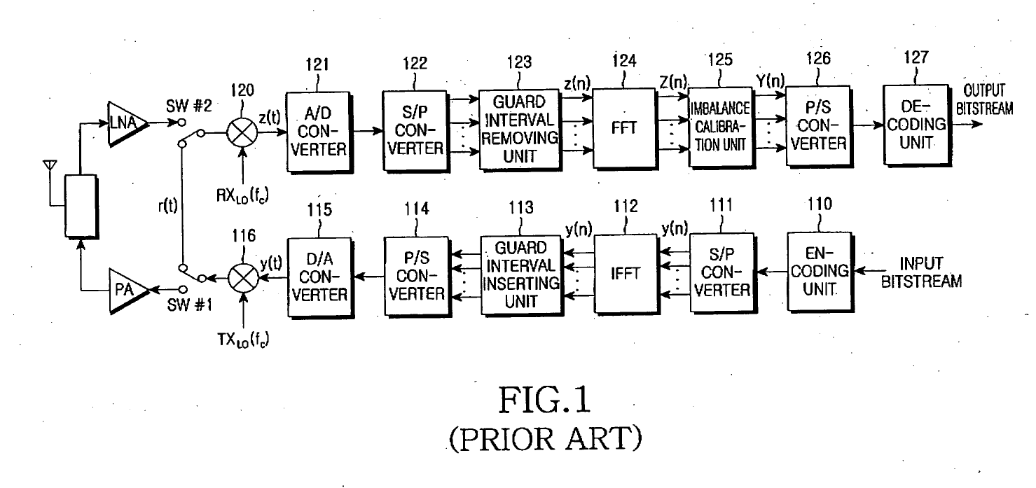

FIG. 1 is a block diagram illustrating the construction of an Orthogonal Frequency Division Multiplexing (OFDM) mobile transceiver according to the present invention.

An input bitstream to be transmitted is provided to an encoding unit 110. The input bitstream may be a signal predetermined for measuring the I/Q imbalance characteristic of a receiver and calibrating the measured I/Q imbalance. For example, a pilot sub-carrier signal may be used as an input bitstream. The encoding unit 110 encodes the input bitstream. An encoded bitstream is output through the encoding operation. The encoded bitstream is provided to a serial-to-parallel (S/P) converter 111. The S/P converter 111 converts the encoded bitstream to a plurality of encoded bitstreams “Y(n)” and outputs the encoded bitstreams “Y(n).” The encoded bitstreams “Y(n)” refer to signals in a frequency domain, and may be allocated according to each sub-carrier. When a pilot sub-carrier signal is used as the input bitstream, the plurality of encoded bitstreams are defined as set forth in Equation (1) below:
\tilde{Y}₋ₘ(n)=\tilde{Y}ₘ(n−1)=1
\tilde{Y}ₘ(n)=\tilde{Y}₋ₘ(n−1)=0 (1)
where “m” represents an index for distinguishing the plurality of encoded bitstreams, and is used to distinguish sub-carriers; “Yₘ(n)” represents an m^{th} pilot sub-carrier signal in an nth OFDM symbol, and “Y₋ₘ(n)” represents a −m^{th} pilot sub-carrier signal in an nth OFDM symbol. Also, “Yₘ(n−1)” represents an m^{th} pilot sub-carrier signal in an (n−1)^{th} OFDM symbol , and “Y₋ₘ(n−1)” represents a −m^{th} pilot sub-carrier signal in an (n−1)^{th} OFDM symbol.

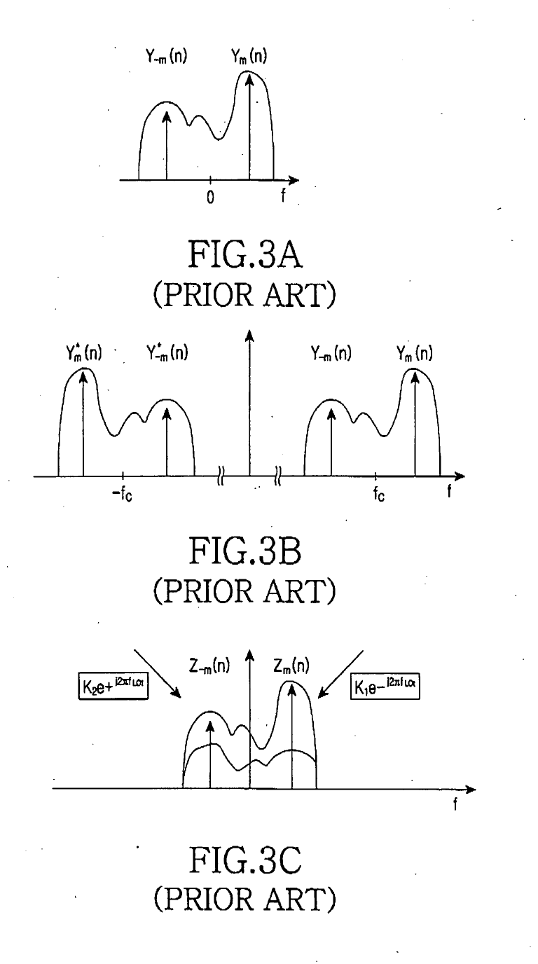

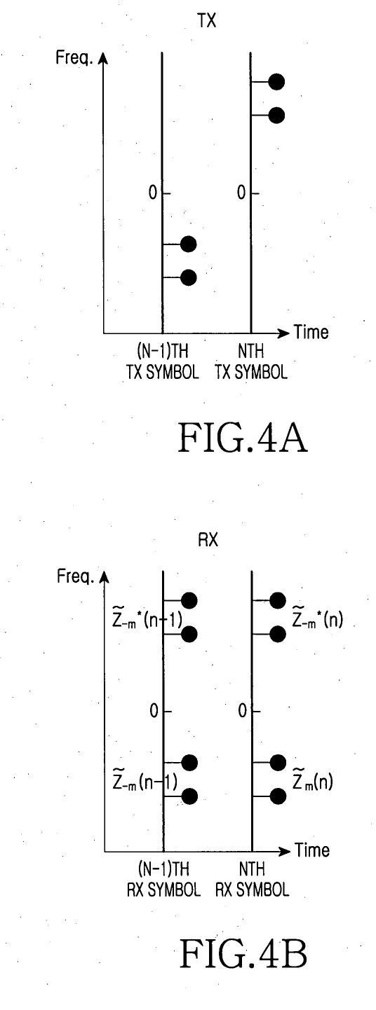

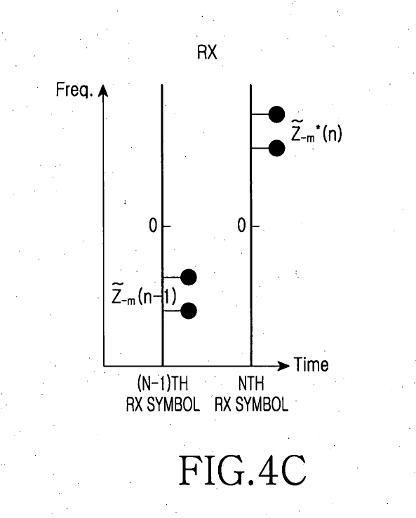

The −m^{th} pilot sub-carrier signal existing in a negative domain and the m^{th} pilot sub-carrier signal existing in a positive domain are illustrated in FIG. 3A. Upon application of Equation (1), the transmitted signals exist only in the negative domain when pilot sub-carrier signals in an (n−1)^{th} OFDM symbol are transmitted,, and, the transmitted signals exist only in the positive domain when pilot sub-carrier signals in an n^{th} OFDM symbol are transmitted, and are illustrated in FIG. 4A.

An Inverse Fast Fourier Transform (IFFT) unit 112 transforms the encoded bitstreams in the frequency domain into a time-domain modulation symbol streams “y(t),”[IN FIG. 1, PLEASE CHANGE “Y(n)” TO “Y(t)” FOLLOWING UNIT 112](→FIG. 1 is correct, but the expression in the description is incorrect. Thus, it is amended in the description.) and outputs the time-domain modulation symbol streams “y(n).” A guard interval inserting unit (i.e., Add Cyclic Prefix) 113 inserts a guard interval to relieve interference between adjacent symbols and multi-path fading. That is, the guard interval inserting unit 113 inserts a signal having the same phase as that of the original signal of each symbol, as a guard interval, into the symbol.

The modulation symbol streams, into each of which the guard interval has been inserted, are outputted as one modulation symbol stream “y(n)” by a parallel-to-serial (P/S) converter 114. A digital-analog (D/A) converter 115 converts the baseband modulation symbol stream “y(t)” into an analog signal. A mixer mixes a carrier “TX_{LO}(f_{c})” with the baseband modulation symbol stream converted into the analog signal, thereby outputting a radio frequency band signal “r(t).” The carrier “TX_{LO}(f_{c})” for transmission may be defined as set forth in Equation (2) below:
TX_{LO}(f_{c})=e^{-j2πfct}+e^{+j2πfct} (2)
where “f_{c}” represents a carrier frequency.

The radio frequency band signal “r(t)” is provided into the receiver through a test route established by a first switch SW #1 and a second switch SW #2. The radio frequency band signal “r(t)” may be defined as set forth in Equation (3) below.

$$\begin{matrix}r ( t ) = y ( t ) {ⅇ}^{+ j 2 π fct} + {y}^{*} ( t ) {ⅇ}^{- j2π fct} \\ = 2 Re ( y ( t ) {ⅇ}^{+ j2π fct} )\end{matrix} \qquad ( 3 )$$

The radio frequency band signal “r(t)” defined as Equation (3) may be expressed as shown in FIG. 3B.

A mixer 120 in the receiver converts the radio frequency band signal “r(t)” into a baseband signal “z(t)” by means of a carrier “RX_{LO}(f_{c}).” The carrier “RX_{LO}(f_{c})” for reception may be defined as set forth in Equation (4) below:
RX_{LO}(f_{c})=K₁e^{-j2πfct}+K₂e^{+j2πfct} (4)
where “K₁” and “K₂” represent error values caused by the I/Q imbalance of the reception carrier. Preferably, “K₁” has a value of “1,” and “K₂” has a value of “0,” which represent a state in which the receiver can completely restore the transmission carrier “y(t).” However, it is almost impossible for “K₁” to have a value of “1” and for “K₂” to have a value of “0,” due to the characteristics of an oscillator. As such, “K₁” and “K₂” may be defined as set forth in Equation (5) below:

$${K}_{1} = \frac{1 + g \cdot {ⅇ}^{- jϕ}}{2} = \frac{1 + g ( cos ϕ - j \cdot sin ϕ )}{2} \\ {K}_{2} = \frac{1 - g \cdot {ⅇ}^{jϕ}}{2} = \frac{1 - g ( cos ϕ + j \cdot sin ϕ )}{2} \qquad ( 5 )$$

where “g” represents a gain imbalance characteristic between an I channel and a Q channel in the receiver, and “i” represents a phase imbalance characteristic between an I channel and a Q channel in the receiver. A carrier of the I channel and a carrier of the Q channel are defined as set forth in Equation (6) below.
LOₗ=cos2πf_{c}t
LO_{g}=g·sin(2πf_{c}t+φ (6)

Therefore, the present invention provides a method for calculating and calibrating the error values “K₁” and “K₂” in a frequency domain. Referring to Equation (5), it can be understood that “K₁” and “K₂” are defined with the gain imbalance characteristic “g” and the phase imbalance characteristic “φ” between I and Q channels.

The baseband signal “z(t)” outputted from the mixer 120 is shown as FIG. 4B as a view of a frequency axis. In FIG. 4B, “\tilde{Z}₋ₘ(n−1)” is a component included due to the I/Q imbalance characteristic of the receiver, corresponding to an (n−1)^{th} pilot sub-carrier signal. In addition, “\tilde{Z}ₘ(n)” is a component included due to the I/Q imbalance characteristic of the receiver, corresponding to an n^{th} pilot sub-carrier signal. Therefore, the “\tilde{Z}₋ₘ*(n−1)” must be removed from a baseband signal corresponding to a pilot sub-carrier signal in an (n−1)^{th} OFDM symbol, and the “\tilde{Z}ₘ(n)” must be removed from a baseband signal corresponding to a pilot sub-carrier signal in an n^{th} OFDM symbol.

The baseband signal “z(t)” is defined as set forth in Equation (7) below:
z(t)=LP{r(t)·\tilde{x}_{LO}(t)}=K₁y(t)+K₂y*(t) (7)
where “LP” represents low pass filtering, and “\tilde{x}_{LO}(t)” represents “RX_{LO}(f_{c})” defined in Equation (4) herein-above. Accordingly, the received signal “r(t)” is multiplied by “\tilde{x}_{LO}(t)” so as to be down-converted, and then a low pass filtering is performed in order to obtain only a desired baseband signal.

An analog-digital (A/D) converter 121 converts the baseband signal “z(t)” output from the mixer 120 into a digital signal, and outputs a digital signal. A serial-to-parallel (S/P) converter 122 converts the baseband signal of a digital form into a plurality of baseband signals, and outputs the plurality of baseband signals.

A guard interval removing unit (i.e., Remove Cyclic Prefix) 123 outputs the plurality of baseband signals after removing guard intervals inserted into each baseband signal. The plurality of baseband signals “z(n),” from which guard intervals have been removed, refer to time-domain signals and are provided to an FFT unit 124. The FFT unit 124 performs an FFT operation with respect to each baseband signal streams z(n), thereby outputting frequency-domain signal streams “Z(n).” The frequency-domain parallel signal streams correspond to encoded bitstreams. The encoded bitstreams “Z(n)” are defined as set forth in Equation (8) below.
Zₘ(n)=K1ₘYₘ(n)=K2ₘY₋ₘ*(n)
Z₋ₘ*(n)=K2*₋ₘYₘ(n)+K1*₋ₘY*₋ₘ(n) (3)

As shown in Equation (8) above-herein, the frequency-domain encoded bitstreams “Z(n)” include components caused by the I/Q imbalance characteristic of the receiver. The encoded bitstreams “Z(n),” including components caused by the I/Q imbalance characteristic of the receiver, are shown in FIG. 3C.

The encoded bitstreams “Z(n),” including components caused by the I/Q imbalance characteristic of the receiver, are provided to an imbalance calibration unit 125. The imbalance calibration unit 125 measures the I/Q imbalance characteristic for each encoded bitstream, and calibrates the I/Q imbalance of each encoded bitstream by using the measured I/Q imbalance characteristic. That is, the imbalance calibration unit 125 removes the components included in each encoded bitstream due to the I/Q imbalance characteristic. A detailed calibrating operation of the I/Q imbalance characteristic will be described herein. A signal obtained after the I/Q imbalance characteristic has been calibrated as shown in FIG. 3C.

The encoded bitstreams “Y(n),” which have been subjected to the calibrating operation of the I/Q imbalance characteristic, are provided to a parallel-to-serial (P/S) converter 126. The parallel-to-serial (P/S) converter 126 performs a parallel-to-serial converting operation with respect to the encoded bitstreams “Y(n),” and thereby outputting one encoded bitstream. The encoded bitstream is provided to a decoding unit 127. The decoding unit 127 decodes the encoded bitstream.

The following is a detailed description of the calibrating operation of the I/Q imbalance characteristic among the operations of the mobile transceiver. Referring to Equation (1), the encoded bitstreams “Z(n−1)” received by a pilot sub-carrier signal in an (n−1)^{th} OFDM symbol may be divided into a signal “Zₘ(n−1)” of a positive domain and a signal “Z₋ₘ*(n−1)” of a negative domain in a frequency domain. The “Zₘ(n−1)” and “Z₋ₘ*(n−1)” may be expressed as a matrix as set forth in Equation (9) below.

$$\begin{matrix}[ \begin{matrix}{Z}_{m} ( n - 1 ) \\ {Z}_{- m}^{*} ( n - 1 )\end{matrix} ] = [ \begin{matrix}K {1}_{m} & K {2}_{m} \\ K {2}_{- m}^{*} & K {1}_{- m}^{*}\end{matrix} ] [ \begin{matrix}{Y}_{m} ( n - 1 ) \\ {Y}_{- m}^{*} ( n - 1 )\end{matrix} ] \\ = K [ \begin{matrix}{Y}_{m} ( n - 1 ) \\ {Y}_{- m}^{*} ( n - 1 )\end{matrix} ]\end{matrix} \qquad ( 9 )$$

Upon expanding Equation (9), two equations as set forth in Equation (10) can be obtained.
Zₘ(n−1)=K1ₘYₘ(n−1)+K2ₘY₋ₘ*(n−1)
Z₋ₘ*(n−1)=K2*₋ₘYₘ(n−1)+K1*₋ₘY*₋ₘ(n−1) (10)

Meanwhile, the encoded bitstreams “Z(n)” received by a pilot sub-carrier signal in an n^{th} OFDM symbol may be divided into a signal “Zₘ(n)” of a positive domain and a signal “Z₋ₘ*(n)” of a negative domain in a frequency domain. The “Zₘ(n)” and “Z₋ₘ*(n)” may be expressed as a matrix as set forth in Equation (11) below.

$$[ \begin{matrix}{Z}_{m} ( n ) \\ {Z}_{- m}^{*} ( n )\end{matrix} ] = [ \begin{matrix}K {1}_{m} & K {2}_{m} \\ K {2}_{- m}^{*} & K {1}_{- m}^{*}\end{matrix} ] [ \begin{matrix}{Y}_{m} ( n ) \\ {Y}_{- m}^{*} ( n )\end{matrix} ] = K [ \begin{matrix}{Y}_{m} ( n ) \\ {Y}_{- m}^{*} ( n )\end{matrix} ] \qquad ( 11 )$$

Upon expanding Equation (11), two equations as set forth in Equation (12) can be obtained.
Zₘ(n)=K1ₘYₘ(n)+K2ₘY₋ₘ*(n)
Z₋ₘ*(n)=K2*₋ₘYₘ(n)+K1*₋ₘY*₋ₘ(n) (12)

As described above, the m^{th} pilot sub-carrier signal in the (n−1)^{th} OFDM symbol and the m^{th} pilot sub-carrier signal in the n^{th} OFDM symbol are predetermined signals, an example of which is defined in Equation (1). That is, an (n−1)^{th} pilot sub-carrier signal has no signal transmitted through the negative domain and it has a signal having a value of “1” transmitted through the positive domain in the frequency domain. In contrast, an n^{th} pilot sub-carrier signal has no signal transmitted through the positive domain and it has a signal having a value of “1” transmitted through the negative domain in the frequency domain.

Therefore, the “Zₘ(n−1)” and “Z₋ₘ*(n−1)” defined in Equation (10) and the “Zₘ(n)” and “Z₋ₘ*(n)” defined in Equation (12) are newly defined as set forth in Equation (13) below.
\tilde{Z}ₘ(n)=K2ₘ
\tilde{Z}₋ₘ*(n)=K1*₋ₘ
\tilde{Z}ₘ(n−1)=K1ₘ
\tilde{Z}₋ₘ*(n−1)=K2*₋ₘ (13)

It can be understood by those skilled in the art that an I/Q imbalance characteristic is measured by applying Equation (14) as set forth below with respect to a pilot sub-carrier signal, instead of Equation 1.
\tilde{Y}₋ₘ(n)=\tilde{Y}ₘ(n−1)=0
\tilde{Y}ₘ(n)=\tilde{Y}₋ₘ(n−1)=1 (14)

Components caused by the I/Q imbalance characteristic of the receiver is measured based on Equation (13). Then, with respect to signals received after the measurement, it is possible to calibrate each encoded bitstream by considering the measured I/Q imbalance characteristic, which is defined as set forth in Equation (15) below.

$$\begin{matrix}[ \begin{matrix}{Y}_{m} ( n ) \\ {Y}_{- m}^{*} ( n )\end{matrix} ] = {K}^{- 1} [ \begin{matrix}{Z}_{m} ( n ) \\ {Z}_{- m}^{*} ( n )\end{matrix} ] \\ = {[ \begin{matrix}K {1}_{m} & K {2}_{m} \\ K {2}_{- m}^{*} & K {1}_{- m}^{*}\end{matrix} ]}^{- 1} [ \begin{matrix}{Z}_{m} ( n ) \\ {Z}_{- m}^{*} ( n )\end{matrix} ] \\ = [ \begin{matrix}{D}_{m} & {E}_{m} \\ {E}_{- m}^{*} & {D}_{- m}^{*}\end{matrix} ] [ \begin{matrix}{Z}_{m} ( n ) \\ {Z}_{- m}^{*} ( n )\end{matrix} ]\end{matrix} \qquad ( 15 )$$

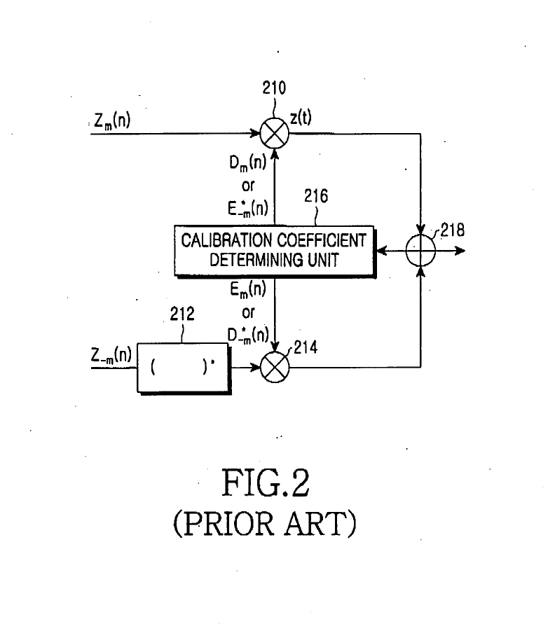

The encoded bitstreams obtained by Equation (14) above refer to signals that have been calibrated with respect to the I/Q imbalance characteristic caused by the mixer of the receiver. Equation (14) may be realized by using a circuit as shown in FIG. 2.

Referring to FIG. 2, a calibration coefficient-determining unit 216 determines calibration coefficients by means of Equation (13) and outputs the determined calibration coefficients. The calibration coefficients determined by the calibration coefficient determining unit 216 include “Dₘ(n)” or “E*₋ₘ(n),” and “Eₘ(n)” or “D*₋ₘ(n).” The calibration coefficient determining unit 216 determines the “Dₘ(n)” and “Eₘ(n)” as a calibration coefficient for a signal “Yₘ(n)” of a received signal, which exists in the positive domain in the frequency domain. In addition, the calibration coefficient determining unit 216 determines the “E*₋ₘ(n)” and “D*₋ₘ(n)” as a calibration coefficient for a signal “Y*₋ₘ(n)” of a received signal, which exists in the negative domain in the frequency domain.

The calibration coefficient determining unit 216 determines final-output “Yₘ(n)” and “Y*₋ₘ(n)” as an input, and continuously tracks the calibration coefficients using the “Yₘ(n)” and “Y*₋ₘ(n).”

“Zₘ(n)” output through the Fast Fourier Transform is multiplied in the first multiplier 210 by the “Dₘ(n)” output from the calibration coefficient determining unit 216, and then the resultant signal is output. Then, “Zₘ(n)” output through the Fast Fourier Transform is output as “Z*₋ₘ(n)” through a unit indicated by reference numeral 212. The “Z*₋ₘ(n)” is multiplied in the second multiplier 214 by the “Eₘ(n)” output from the calibration coefficient determining unit 216, and then the resultant signal is output. These signals output from the first multiplier 210 and second multiplier 214 are added by an adder 218 and output as “Yₘ(n).”

The next “Zₘ(n)” output through the Fast Fourier Transform is multiplied in the first multiplier 210 by the “E*₋ₘ(n)” output from the calibration coefficient determining unit 216, and then the resultant signal is output. Then, “Z₋ₘ(n)” output through the Fast Fourier Transform is output as “Z*₋ₘ(n)” through a unit indicated by reference numeral 212. The “Z*₋ₘ(n)” is multiplied in the second multiplier 214 by the “D*₋ₘ(n)” output from the calibration coefficient determining unit 216, and then the resultant signal is output. These signals output from the first multiplier 210 and second multiplier 214 are added by the adder 218 and output as “Y*₋ₘ(n).”

While the foregoing description has been given of a case in which a mobile transceiver measures a calibration coefficient by itself and calibrates an I/Q imbalance characteristic of a received signal based on the measured calibration coefficient, the mobile transceiver may measure a calibration coefficient using a received signal.

In order to measure a calibration coefficient using a received signal, it is necessary to additionally consider signals “Cₘ” and “C*₋ₘ”

transmitted from a transmitter, an effect of noise according to the channel environment, and a change in the channel environment.

In this case, Equations (9) to (13) and (15) may be replaced by following Equations (16) to (21) as set forth below, which are to be applied.

$$\begin{matrix}[ \begin{matrix}{Z}_{m} ( n - 1 ) \\ {Z}_{- m}^{*} ( n - 1 )\end{matrix} ] = [ \begin{matrix}{C}_{m} & 0 \\ 0 & {C}_{- m}^{*}\end{matrix} ] [ \begin{matrix}K {1}_{m} & K {2}_{m} \\ K {2}_{- m}^{*} & K {1}_{- m}^{*}\end{matrix} ] [ \begin{matrix}{Y}_{m} ( n - 1 ) \\ {Y}_{- m}^{*} ( n - 1 )\end{matrix} ] + [ \begin{matrix}{N}_{m} ( n - 1 ) \\ {N}_{- m}^{*} ( n - 1 )\end{matrix} ] \\ = K [ \begin{matrix}{Y}_{m} ( n - 1 ) \\ {Y}_{- m}^{*} ( n - 1 )\end{matrix} ] + [ \begin{matrix}{N}_{m} ( n - 1 ) \\ {N}_{- m}^{*} ( n - 1 )\end{matrix} ]\end{matrix} \qquad ( 16 )$$

Zₘ(n−1)=CₘK1ₘYₘ(n−1)+CₘK2ₘY₋ₘ*(n−1)
Z₋ₘ*(n−1)=C*₋ₘK2*₋ₘYₘ(n−1)+C*₋ₘK1*₋ₘY*₋ₘ(n−1) (17)

$$\begin{matrix}[ \begin{matrix}{Z}_{m} ( n - 1 ) \\ {Z}_{- m}^{*} ( n - 1 )\end{matrix} ] = [ \begin{matrix}{C}_{m} & 0 \\ 0 & {C}_{- m}^{*}\end{matrix} ] [ \begin{matrix}K {1}_{m} & K {2}_{m} \\ K {2}_{- m}^{*} & K {1}_{- m}^{*}\end{matrix} ] [ \begin{matrix}{Y}_{m} ( n ) \\ {Y}_{- m}^{*} ( n )\end{matrix} ] + [ \begin{matrix}{N}_{m} ( n ) \\ {N}_{- m}^{*} ( n )\end{matrix} ] \\ = K [ \begin{matrix}{Y}_{m} ( n ) \\ {Y}_{- m}^{*} ( n )\end{matrix} ] + [ \begin{matrix}{N}_{m} ( n ) \\ {N}_{- m}^{*} ( n )\end{matrix} ]\end{matrix} \qquad ( 18 )$$

Zₘ(n)=CₘK1ₘYₘ(n)+CₘK2ₘY₋ₘ*(n)
Z₋ₘ*(n)=C*₋ₘK2*₋ₘYₘ(n)+C*₋ₘK1*₋ₘY*₋ₘ(n) (19)
\tilde{Z}ₘ(n)=CₘK2ₘ
\tilde{Z}₋ₘ*(n)=C*₋ₘK1*₋ₘ
\tilde{Z}ₘ(n−1)=CₘK1ₘ
\tilde{Z}₋ₘ*(n−1)=C*₋ₘK2*₋ₘ (20)

$$\begin{matrix}[ \begin{matrix}{Y}_{m} ( n ) \\ {Y}_{- m}^{*} ( n )\end{matrix} ] = {K}^{- 1} [ \begin{matrix}{Z}_{m} ( n ) \\ {Z}_{- m}^{*} ( n )\end{matrix} ] \\ = {[ \begin{matrix}{C}_{m} K {1}_{m} & {C}_{m} K {2}_{m} \\ {C}_{- m}^{*} K {2}_{- m}^{*} & {C}_{- m}^{*} K {1}_{- m}^{*}\end{matrix} ]}^{- 1} [ \begin{matrix}{Z}_{m} ( n ) \\ {Z}_{- m}^{*} ( n )\end{matrix} ] \\ = [ \begin{matrix}{F}_{m} & {G}_{m} \\ {G}_{- m}^{*} & {F}_{- m}^{*}\end{matrix} ] [ \begin{matrix}{Z}_{m} ( n ) \\ {Z}_{- m}^{*} ( n )\end{matrix} ]\end{matrix} \qquad ( 21 )$$

In the equations, noise components are not considered when Equation (16) is expanded to Equation (17) and when Equation (18) is expanded to Equation (19). In addition, the present invention has been described on the assumption that the channel environment is not changed while the (n−1)^{th} OFDM symbol and the n^{th} OFDM symbol are being transmitted.

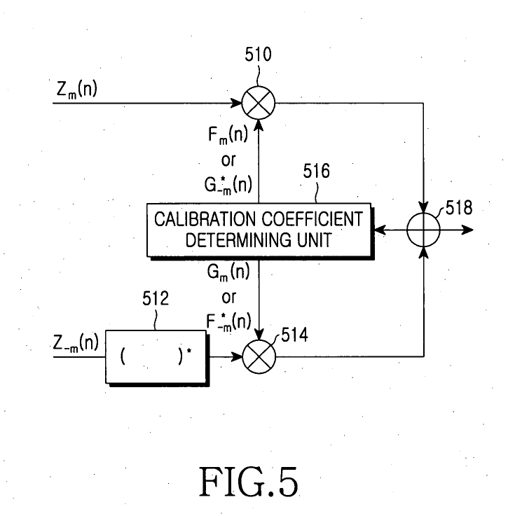

FIG. 5 is a block diagram illustrating a construction for measuring calibration coefficients based on Equation (21) above, and for calibrating an I/Q imbalance characteristic of a received signal by using the measured calibration coefficients.

As can be understood from the foregoing description, the present invention measures an I/Q imbalance characteristic not in the time domain, but in the frequency domain, and calibrates the measured I/Q imbalance characteristic. Accordingly, the present invention can be easily employed as a solution for calibrating an I/Q imbalance characteristic of an OFDM mobile receiver using a broadband channel. Furthermore, since the present invention utilizes a pilot signal, it is possible to simultaneously perform channel estimation and calibration of an I/Q imbalance characteristic. In addition, since the present invention does not use multiplication and division operations, the operation for processing digital signals can be simplified.

While the present invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for calibrating an imbalance characteristic in a mobile receiver, which supports an Orthogonal Frequency Division Multiplexing (OFDM) scheme, the apparatus comprising:
a mixer for converting a received signal of a Radio Frequency (RF) band into a baseband signal by using a carrier;
a Fast Fourier Transform (FFT) unit for converting the baseband received signal from a time domain to a frequency domain; and
an imbalance calibration unit for measuring a calibration coefficient by using two consecutively received signals from the FFT unit, and removing an imbalance component included in the received signal of the frequency domain due to a characteristic of the mixer by using the measured calibration coefficient, wherein the two consecutively received signals refer to two transmission signals consecutively-transmitted from a transmitter, and the two transmission signals are predetermined signals.

2. The apparatus as claimed in claim 1, wherein the received signal of the radio frequency band refers to a transmission signal of the radio frequency band output from the transmitter, and is transferred through a test route connected between an output terminal of the transmitter and an input terminal of the receiver.

3. The apparatus as claimed in claim 2, wherein the predetermined signals are defined as “\tilde{Y}₋ₘ(n)=\tilde{Y}ₘ(n−1)=1” and “\tilde{Y}ₘ(n)=\tilde{Y}₋ₘ(n−1)=0.”

4. The apparatus as claimed in claim 3, wherein the calibration coefficient is measured using
\tilde{Z}ₘ(n)=K2ₘ
\tilde{Z}₋ₘ*(n)=K1*₋ₘ
\tilde{Z}ₘ(n−1)=K1ₘ
\tilde{Z}₋ₘ*(n−1)=K2*₋ₘ

5. The apparatus as claimed in claim 4, wherein the imbalance component included in the received signal of the frequency domain is calibrated by
$$[ \begin{matrix}{Y}_{m} ( n ) \\ {Y}_{- m}^{*} ( n )\end{matrix} ] = {K}^{- 1} [ \begin{matrix}{Z}_{m} ( n ) \\ {Z}_{- m}^{*} ( n )\end{matrix} ] = {[ \begin{matrix}K {1}_{m} & K {2}_{m} \\ K {2}_{- m}^{*} & K {1}_{- m}^{*}\end{matrix} ]}^{- 1} [ \begin{matrix}{Z}_{m} ( n ) \\ {Z}_{- m}^{*} ( n )\end{matrix} ] .$$

6. The apparatus as claimed in claim 1, wherein the received signal of the radio frequency band refers to a transmission signal of the radio frequency band output from the transmitter, and is transmitted through a radio channel.

7. The apparatus as claimed in claim 6, wherein the predetermined signals are defined as “\tilde{Y}₋ₘ(n)=\tilde{Y}ₘ(n−1)=1” and “\tilde{Y}ₘ(n)=\tilde{Y}₋ₘ(n−1)=0.”

8. The apparatus as claimed in claim 7, wherein the calibration coefficient is measured by
\tilde{Z}ₘ(n)=CₘK2ₘ
\tilde{Z}₋ₘ*(n)=C*₋ₘK1*₋ₘ
\tilde{Z}ₘ(n−1)=CₘK1ₘ
\tilde{Z}₋ₘ*(n−1)=C*₋ₘK2*₋ₘ

9. The apparatus as claimed in claim 8, wherein the imbalance component included in the received signal of the frequency domain is calibrated by
$$\begin{matrix}[ \begin{matrix}{Y}_{m} ( n ) \\ {Y}_{- m}^{*} ( n )\end{matrix} ] = {K}^{- 1} [ \begin{matrix}{Z}_{m} ( n ) \\ {Z}_{- m}^{*} ( n )\end{matrix} ] \\ = {[ \begin{matrix}{C}_{m} K {1}_{m} & {C}_{m} K {2}_{m} \\ {C}_{- m}^{*} K {2}_{- m}^{*} & {C}_{- m}^{*} K {1}_{- m}^{*}\end{matrix} ]}^{- 1} [ \begin{matrix}{Z}_{m} ( n ) \\ {Z}_{- m}^{*} ( n )\end{matrix} ] \\ = [ \begin{matrix}{D}_{m} & {E}_{m} \\ {E}_{- m}^{*} & {D}_{- m}^{*}\end{matrix} ] [ \begin{matrix}{Z}_{m} ( n ) \\ {Z}_{- m}^{*} ( n )\end{matrix} ] .\end{matrix}$$

10. A method for calibrating an imbalance characteristic in a mobile receiver which supports an Orthogonal Frequency Division Multiplexing (OFDM) scheme, the method comprising the steps of:
converting a received signal of a radio frequency band into a baseband signal by using a carrier;
converting the baseband received signal from a time domain to a frequency domain;
measuring a calibration coefficient by using two consecutively received signals from the Fast Fourier Transform (FFT) unit; and
removing an imbalance component included in the received signal of the frequency domain due to an imbalance of the carrier, by using the measured calibration coefficient,
wherein the two consecutively received signals refer to two transmission signals consecutively transmitted from a transmitter, and the two transmission signals are predetermined signals.

11. The method as claimed in claim 10, wherein the received signal of the radio frequency band refers to a transmission signal of the radio frequency band output from the transmitter, and is transferred through a test route connected between an output terminal of the transmitter and an input terminal of the receiver.

12. The method as claimed in claim 11, wherein the predetermined signals are defined as “\tilde{Y}₋ₘ(n)=\tilde{Y}ₘ(n−1)=1” and “\tilde{Y}ₘ(n)=\tilde{Y}₋ₘ(n−1)=0.”

13. The method as claimed in claim 12, wherein the calibration coefficient is measured using
\tilde{Z}ₘ(n)=K2ₘ
\tilde{Z}₋ₘ*(n)=K1*₋ₘ
\tilde{Z}ₘ(n−1)=K1ₘ
\tilde{Z}₋ₘ*(n−1)=K2*₋ₘ

14. The method as claimed in claim 13, wherein the imbalance component included in the received signal of the frequency domain is calibrated by
$$[ \begin{matrix}{Y}_{m} ( n ) \\ {Y}_{- m}^{*} ( n )\end{matrix} ] = {K}^{- 1} [ \begin{matrix}{Z}_{m} ( n ) \\ {Z}_{- m}^{*} ( n )\end{matrix} ] = {[ \begin{matrix}K {1}_{m} & K {2}_{m} \\ K {2}_{- m}^{*} & K {1}_{- m}^{*}\end{matrix} ]}^{- 1} [ \begin{matrix}{Z}_{m} ( n ) \\ {Z}_{- m}^{*} ( n )\end{matrix} ] .$$

15. The method as claimed in claim 10, wherein the received signal of the radio frequency band refers to a transmission signal of the radio frequency band output from the transmitter, and is transmitted through a radio channel.

16. The method as claimed in claim 15, wherein the predetermined signals are defined as “\tilde{Y}₋ₘ(n)=\tilde{Y}ₘ(n−1)=1” and “\tilde{Y}ₘ(n)=\tilde{Y}₋ₘ(n−1)=0.”

17. The method as claimed in claim 16, wherein the calibration coefficient is measured by
\tilde{Z}ₘ(n)=CₘK2ₘ
\tilde{Z}₋ₘ*(n)=C*₋ₘK1*₋ₘ
\tilde{Z}ₘ(n−1)=CₘK1ₘ
\tilde{Z}₋ₘ*(n−1)=C*₋ₘK2*₋ₘ

18. The method as claimed in claim 17, wherein the imbalance component included in the received signal of the frequency domain is calibrated by
$$\begin{matrix}[ \begin{matrix}{Y}_{m} ( n ) \\ {Y}_{- m}^{*} ( n )\end{matrix} ] = {K}^{- 1} [ \begin{matrix}{Z}_{m} ( n ) \\ {Z}_{- m}^{*} ( n )\end{matrix} ] \\ = {[ \begin{matrix}{C}_{m} K {1}_{m} & {C}_{m} K {2}_{m} \\ {C}_{- m}^{*} K {2}_{- m}^{*} & {C}_{- m}^{*} K {1}_{- m}^{*}\end{matrix} ]}^{- 1} [ \begin{matrix}{Z}_{m} ( n ) \\ {Z}_{- m}^{*} ( n )\end{matrix} ] \\ = [ \begin{matrix}{D}_{m} & {E}_{m} \\ {E}_{- m}^{*} & {D}_{- m}^{*}\end{matrix} ] [ \begin{matrix}{Z}_{m} ( n ) \\ {Z}_{- m}^{*} ( n )\end{matrix} ] .\end{matrix}$$
